(19) United States
(12) Patent Application Publication
(10) Pub. No.: US 2025/0273197 A1
(43) Pub. Date: Aug. 28, 2025

(54) SYSTEM AND METHOD FOR SPEECH-TO-TEXT CONVERSION OF PASSENGER ANNOUNCEMENTS ON BOARD OF AN AIRCRAFT

(71) Applicant: Airbus Operations GmbH, HAMBURG (DE)

(72) Inventors: Stefan SCHULZ, HAMBURG (DE); Sven-Olaf BERKHAHN, HAMBURG (DE)

(21) Appl. No.: 19/063,851

(22) Filed: Feb. 26, 2025

(30) Foreign Application Priority Data
Feb. 28, 2024 (EP) 24160398.4

(51) Int. Cl. G10L 13/04

(52) U.S. Cl. CPC G10L 13/04

(57) ABSTRACT

A system for speech-to-text conversion of passenger announcements on board of an aircraft comprises a cabin management control configured to provide a speech signal related to an announcement to passengers on board of the aircraft; a cabin application server comprising a processing unit configured to convert the speech signal into a text message containing text corresponding to spoken words of the speech signal, wherein the processing unit is configured to convert the speech signal locally without accessing online computing resources; and a network interface configured to provide the text message to at least one passenger device on board of the aircraft.

### CROSS-REFERENCES TO RELATED APPLICATIONS

This application claims the benefit of European Patent Application Number 24160398.4 filed on Feb. 28, 2024, the entire disclosure of which is incorporated herein by way of reference.

### FIELD OF THE INVENTION

The present invention pertains to a system and a method for speech-to-text conversion of passenger announcements on board of an aircraft.

### BACKGROUND OF THE INVENTION

Various announcements are usually made on board of aircraft by aircraft personnel, e.g., flight attendants and/or pilots. For example, such announcements may be made before or after take-off and landing. In general, two different types of announcements exist on board of aircraft, the first being pre-recorded announcements and the second being live announcements. Pre-recorded announcements are sometimes called Pre-Recorded Announcements and Music (PRAM) and live announcements are often called Passenger Address (PA) announcements. Both of these announcements are usually announced or advertised to passengers by a so-called chime. A chime is a certain tone or jingle indicating that an announcement is going to be made. Further, during an announcement, a message may be displayed on passenger displays of an In-Flight Entertainment (IFE) system. For example, such a message may read “announcement in progress” or the like.

However, for deaf or hearing-impaired passengers it is difficult if not impossible to follow such announcements. Further, passengers might be distracted and/or might not listen carefully to the announcement made. On top of that, language barriers may be an issue.

EP 3 107 090 A1 describes a method where a text message is generated based on a speech signal related to a passenger announcement, which is then be distributed to passenger devices. To this end, speech-to-text (STT) techniques are employed, that is, computer-implemented assistance for translating spoken language into text.

However, in order to make use of such computer implemented solutions it is usually necessary to have a more or less permanent internet connection to an online server and/or cloud computing infrastructure providing the translation software modules that facilitate the conversion.

### SUMMARY OF THE INVENTION

Against this background, there is a need for an improved technique for signaling announcements to passengers on board of an aircraft.

This object may be achieved by a system, an aircraft, and/or a method having the features of one or more embodiments desideria herein.

According to the invention, a system for speech-to-text conversion of passenger announcements on board of an aircraft comprises a cabin management control configured to provide a speech signal related to an announcement to passengers on board of the aircraft; a cabin application server comprising a processing unit configured to convert the speech signal into a text message containing text corresponding to spoken words of the speech signal, wherein the processing unit is configured to convert the speech signal locally without accessing online computing resources; and a network interface configured to provide the text message to at least one passenger device on board of the aircraft.

Further according to the invention, an aircraft comprises a system according to the invention.

Further according to the invention, a method for speech-to-text conversion of passenger announcements on board of an aircraft comprises providing, by a cabin management control, a speech signal related to an announcement to passengers on board of the aircraft; converting, by a processing unit of a cabin application server, the speech signal into a text message containing text corresponding to spoken words of the speech signal, wherein the processing unit converts the speech signal locally without accessing online computing resources; and providing, by a network interface, the text message to at least one passenger device on board of the aircraft.

Further according to the invention, a computer program product is provided. The computer program product comprises program code for carrying out one or more of the steps of any of the method aspects described herein, when the computer program product is run or executed on a computer system or on one or more computing devices. The computer program product may be stored on a computer readable recording medium, such as a permanent or rewritable memory, or may be downloadable.

Thus, one idea of the present invention is to provide the cabin infrastructure of an aircraft with the means for facilitating offline speech-to-text conversion of passenger announcements. To this end, the invention provides an application-specific processing unit as part of the cabin equipment on board of the aircraft that is able to run the required speech-to-text conversion software locally and offline, that is, without accessing online computing resources like cloud processing and the like.

Today, announcements of the cabin crew are mostly still done verbally and live. Hence, there is usually no possibility for passengers to re-play an announcement in case they have not understood all details or to (re-)read the announcement in text form at a later point in time (e.g., in case of hearing impaired persons). On the other hand, state of the art solutions based on speech-to-text conversion and/or speech recognition that could be used to improve this situation normally rely on a stable internet connection and may thus not be suitable for the use on board of an aircraft where a permanent internet connection may not be guaranteed at any time.

To overcome these problems, the present invention provides dedicated computing equipment on board of the aircraft specifically designed for the above purpose, which can be run without any internet connection whatsoever. Hence, verbal passenger announcements can be translated in-situ and potentially almost live even in an emergency situation where an internet connection may not be available at least for some period of time. The main advantage is that any passenger (not only hearing impaired passengers) have the option to re-play and/or to (re-)read spoken live announcements of cabin or cockpit crew on their own devices (mobile phones, tablets, laptops etc.) as long as these devices are linked to the respective on-board network and/or storage system providing the respective textual form of the announcement.

Advantageous embodiments and improvements of the present invention are found in the subordinate claims.

According to an embodiment of the invention, the processing unit may comprise an AI accelerator, in particular a tensor processing unit, configured to utilize at least one of AI and machine learning for converting the speech signal.

An AI accelerator, deep learning processor, and/or neural processing unit is a class of specialized hardware accelerator or computer system designed to accelerate artificial intelligence and machine learning applications, including artificial neural networks and machine vision. A tensor processing unit is a particular example for such application-specific processing equipment that can be used for the present purpose. In that sense, any custom-made and/or generally available AI trained speech-to-text software and/or hardware solution may be employed for the present purpose as long as it can be run locally without a permanent internet connection. In other words, the invention enhances the normal computing infrastructure of a passenger cabin with a tensor processing unit or similar in order to remain independent of internet access for the conversion of passenger announcements.

According to an embodiment of the invention, the processing unit may be configured to translate the speech signal from a source language to a target language as part of the conversion. The network interface may be configured to provide a correspondingly translated text message to the at least one passenger device on board of the aircraft.

Hence, as a further option the announcements are not only transcribed/converted but also translated from a source language to one or several other languages via the AI modules of the processing unit. In that vein, passengers may receive the announcement in basically any preferred language.

According to an embodiment of the invention, the processing unit may be configured to generate a correspondingly translated speech signal containing spoken words corresponding to text of the translated text message. The network interface may be configured to provide the translated speech signal to the at least one passenger device on board of the aircraft.

Hence, the translated version may not only be provided in text form but also as spoken words generated by the processing unit.

According to an embodiment of the invention, the system may further comprise a data storage. The cabin management control may be configured to record a live audio announcement as speech signal and store it in the data storage and/or to store the text message, the translated text message and/or the translated speech signal in the data storage.

In that way, announcements could also be accessed and/or reused at a later point in time from the data storage.

According to an embodiment of the invention, the cabin management control may be configured to provide a notification signal to the at least one passenger device via the network interface notifying the at least one passenger device that an announcement is made.

For example, for hearing impaired persons there may be a vibration or similar signal on a mobile phone or other device that is triggered by a respective announcement signal from the cabin management control. Alternatively, or additionally, such a notification signal may also be triggered automatically by the respective passenger device, e.g., by a detection of a spoken announcement via one or several microphones integrated in the passenger device and/or the aircraft cabin. A corresponding trigger signal may also be sent out by the cabin application server.

The invention will be explained in greater detail with reference to exemplary embodiments depicted in the drawings as appended.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. In the figures, like reference numerals denote like or functionally like components, unless indicated otherwise.

FIG. 1 schematically depicts a system for speech-to-text conversion of passenger announcements on board of an aircraft according to an embodiment of the invention.

FIG. 2 depicts a schematic flow diagram for a corresponding method according to an embodiment of the invention.

### DETAILED DESCRIPTION OF THE PREFERRED EMBODIMENTS

Although specific embodiments are illustrated and described herein, it will be appreciated by those of ordinary skill in the art that a variety of alternate and/or equivalent implementations may be substituted for the specific embodiments shown and described without departing from the scope of the present invention. Generally, this application is intended to cover any adaptations or variations of the specific embodiments discussed herein.

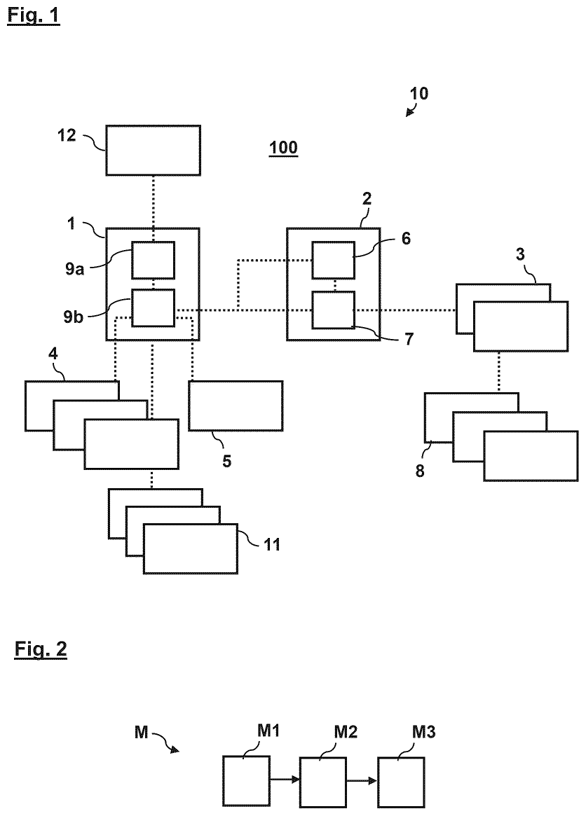

FIG. 1 schematically depicts a system 10 for speech-to-text conversion of passenger announcements on board of an aircraft 100 according to an embodiment of the invention. FIG. 2 depicts a schematic flow diagram for a corresponding method M according to an embodiment of the invention.

The system 10 and method M are provided to convert announcements of the aircraft crew into text messages that can be read by the passengers on their own devices immediately after (or even still during the announcement) or at a later point in time. The thus generated text messages serve as an alternative in case a passenger missed an announcement for whatever reason or in case a passenger is not able to hear and/or understand the announcement.

The basic idea is to make use of AI/machine learning technology for offline speech-to-text conversion for passenger announcements. An already existing cabin management system with passenger address (PA) function for audio announcements by cabin or cockpit crew or announcements coming from an integrated pre-recorded announcement module (iPRAM) function may be used as it is. This basic system can then be enhanced by the present teachings with a dedicated AI accelerator processing unit in order to be able to convert speech to text offline locally and without having to rely on online computing resources, as will be explained in detail now.

The system 10 comprises a cabin management control 1 adapted for controlling a cabin management system as it is known in the art. Such a system generally provides an interface for the cabin crew to monitor and control all aircraft functions related to the cabin. The cabin management control 1 amongst others offers a recorded passenger announcement function 9a and a live passenger announcement function 9b.

The recorded passenger announcement function 9a is used to make pre-recorded announcements, i.e., Pre-Recorded Announcements and Music (PRAM). To this end, the cabin management control 1 can access an audio source 12, e.g., a data storage, providing pre-recorded announcements and other sound files, which may be retrieved from the audio source 12 by the cabin management control 1 and then forwarded to at least one loudspeaker 11 installed within the cabin on board of the aircraft 100.

The live passenger announcement function 9b on the other hand is used to manage live announcements, i.e., Passenger Address (PA) announcements, which are made by the cabin or cockpit crew via cabin crew devices 4 (e.g., a crew handset) and cockpit crew devices 5 (e.g., cockpit audio management unit or also a crew handset), respectively, and broadcasted via the loudspeakers 11 of the cabin.

The cabin management control 1 provides the above announcements as speech signals. The system 10 further comprises a cabin application server 2, which receives these speech signals from the cabin management control 1, e.g., via an analog and/or digital audio interface (potentially together with audio control signals, not shown in FIG. 1).

The cabin application server 2 comprises a processing unit 6 configured to convert the speech signal into a text message containing text corresponding to spoken words of the speech signal. More specifically, the processing unit 6 is configured to convert the speech signal locally without accessing online computing resources. The processing unit 6 may be in particular a tensor processing unit or other AI accelerator that can be operated offline without connection to cloud processing or other online services and which can execute suitable AI and/or machine learning modules for converting spoken language to written text.

The terminology “to convert” may also be understood herein as “to transcribe”. For example, speech recognition may be performed on a speech signal that is transmitted as an audio announcement to passengers via loudspeakers 11 installed in the cabin of the aircraft 100. A text message thus generated may form a simultaneous textual representation of the audio announcement and may be provided to passengers in addition to the audio announcement itself.

To this end, the system 10 further comprises a network interface 3 configured to provide the text message to at least one passenger device 8 on board of the aircraft, e.g., a mobile phone, a laptop, a tablet or other portable device used by passengers.

The processing unit 6 may not only transcribe speech to written text but may also be configured to translate the speech signal from a source language to a target language as part of the conversion, which may then be provided to the at least one passenger device 8 by the network interface 3. The processing unit 6 may hence be used to run AI-based pre-trained multilingual speech-to-text software modules to convert offline locally by means of the cabin application server without any online cloud processing.

Furthermore, the processing unit 6 may be configured to generate a correspondingly translated speech signal containing spoken words corresponding to text of the translated text message, which may then also be provided to the at least one passenger device 8 by the network interface 3.

The system 10 further comprises a data storage 7 that can be used for storing a recorded version of each live audio announcement as well as for storing the corresponding text messages, translated text messages and/or translated speech signals. In the exemplary embodiment of FIG. 1, the data storage is integrated in the cabin application server 2.

The passengers may thus read a text version of a live announcement in any preferred language and may in addition even listen to translated versions of it. Passengers may connect their mobile phones or tablets or other devices to the network interface, which may be, for example, a WiFi access point that is installed in the aircraft cabin. Via the WiFi connection the passengers have access to the data files stored on the data storage 7 of the cabin application server 2. Via an app or a browser or other software tool on the passenger devices 8 the passengers can re-play the audio announcements and listen to them via headphones plugged into passenger devices 8. Or, alternatively or additionally, the passengers can read the announcements stored on the cabin application server 2 on their devices 8.

The cabin management control 1 may be further configured to provide a notification signal to the at least one passenger device 8 via the network interface 3 notifying the at least one passenger device 8 that an announcement is made. For example, for hearing impaired persons there may be a vibration signal on a mobile phone, which may be triggered by the speech signal from the cabin management control (indication of an active announcement). In another example, a noise, sound and/or speech detection function may be run on the cabin application server 2 so that whenever an announcement is made, an automatic indication can be forwarded to some or all passengers notifying them that there is a new announcement available.

The passengers may be able to choose in advance in which language they would like to listen to or would like to read the announcements. Hence, it can be made sure that each passenger receives the announcements in his/her mother language or any preferred language (independent of the live spoken announcements of the cabin or cockpit crew).

The main advantage of the present system is that any passenger (not only hearing impaired passengers) have the option to re-play or to read the verbal spoken live announcements of cabin or cockpit crew on their own devices (mobile phones, tablets, laptops etc.) linked to the on-board WiFi system. This is further enhanced by a multi-language translation option for written and spoken texts.

The corresponding method M of FIG. 2 thus comprises under M1 providing with the cabin management control 1 a speech signal related to an announcement to passengers on board of the aircraft 100, under M2 converting with the processing unit 6 of the cabin application server 2 the speech signal into a text message containing text corresponding to spoken words of the speech signal offline locally without accessing online computing resources, and under M3 providing with the network interface 3 the text message to at least one passenger device 8 on board of the aircraft 100.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents. Many other examples will be apparent to one skilled in the art upon reviewing the above specification. The embodiments were chosen and described in order to best explain the principles of the invention and its practical applications, to thereby enable others skilled in the art to best utilize the invention and various embodiments with various modifications as are suited to the particular use contemplated.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 cabin management control
2 cabin application server
3 network interface
4 cabin crew device
5 cockpit crew device
6 processing unit
7 data storage
8 passenger device
9a recorded passenger announcement function
9b live passenger announcement function
10 system
11 loudspeaker
12 audio source
100 aircraft
M method
M1-M3 method steps

Claimed is:

1. A system for speech-to-text conversion of passenger announcements on board of an aircraft, the system comprising:
a cabin management control configured to provide a speech signal related to an announcement to passengers on board of an aircraft;
a cabin application server comprising a processing unit configured to convert the speech signal into a text message containing text corresponding to spoken words of the speech signal, wherein the processing unit is configured to convert the speech signal locally without accessing online computing resources; and
a network interface configured to provide the text message to at least one passenger device on board of the aircraft.

2. The system according to claim 1, wherein the processing unit comprises an AI accelerator configured to utilize at least one of AI and machine learning for converting the speech signal.

3. The system according to claim 1, wherein the processing unit is configured to translate the speech signal from a source language to a target language as part of the conversion,
wherein the network interface is configured to provide a correspondingly translated text message to the at least one passenger device on board of the aircraft.

4. The system according to claim 3, wherein the processing unit is configured to generate a correspondingly translated speech signal containing spoken words corresponding to text of the translated text message, and
wherein the network interface is configured to provide the translated speech signal to the at least one passenger device on board of the aircraft.

5. The system according to claim 1, further comprising:
a data storage,
wherein the cabin management control is configured to at least one of:
record a live audio announcement as speech signal and store the live audio announcement in the data storage; and
store at least one of the text message, the translated text message, and the translated speech signal in the data storage.

6. The system according to claim 1, wherein the cabin management control is configured to provide a notification signal to the at least one passenger device via the network interface notifying the at least one passenger device that an announcement is made.

7. An aircraft comprising:
the system according to claim 1.

8. A method for a speech-to-text conversion of passenger announcements on board of an aircraft, the method comprising:
providing, by a cabin management control, a speech signal related to an announcement to passengers on board of an aircraft;
converting, by a processing unit of a cabin application server, the speech signal into a text message containing text corresponding to spoken words of the speech signal, wherein the processing unit converts the speech signal locally without accessing online computing resources; and
providing, by a network interface, the text message to at least one passenger device on board of the aircraft.

9. The method according to claim 8, wherein the processing unit comprises an AI accelerator utilizing at least one of AI and machine learning for converting the speech signal.

10. The method according to claim 8, wherein the processing unit translates the speech signal from a source language to a target language as part of the speech-to-text conversion,
wherein the network interface provides a correspondingly translated text message to the at least one passenger device on board of the aircraft.

11. The method according to claim 10, wherein the processing unit generates a correspondingly translated speech signal containing spoken words corresponding to text of the translated text message,
wherein the network interface provides the translated speech signal to the at least one passenger device on board of the aircraft.

12. The method according to claim 8, wherein the cabin management control performs at least one of:
recording a live audio announcement as speech signal and storing the live audio announcement in a data storage; and
storing at least one of the text message, the translated text message, and the translated speech signal in a data storage.

13. The method according to claim 8, wherein the cabin management control provides a notification signal to the at least one passenger device via the network interface notifying the at least one passenger device that an announcement is made.

14. A non-transitory computer readable medium comprising storing a computer program configured to perform the method of claim 8 when the computer program is executed by a processor.
